(19) United States
(12) Patent Application Publication
(10) Pub. No.: US 2022/0315861 A1
(43) Pub. Date: Oct. 6, 2022

(54) Sage Candle Systems

(71) Applicant: Itamar Zamor, Lithonia, GA (US)

(72) Inventor: Itamar Zamor, Lithonia, GA (US)

(21) Appl. No.: 17/711,869

(22) Filed: Apr. 1, 2022

Related U.S. Application Data
(60) Provisional application No. 63/169,712, filed on Apr. 1, 2021.

(51) Int. Cl. C11C 5/00

(52) U.S. Cl. CPC C11C 5/008; C11C 5/002; C11C 5/006

(57) ABSTRACT

A sage candle system suitable for use as a sage candle is provided. The system includes a longitudinal wick. The system also includes aggregate material configured for use as a candle arranged in a cylindrical fashion around the longitudinal wick. Additionally, the system includes an external covering material designed to cover an exterior surface of the aggregate material; and external strapping material positionable on an exterior surface of the covering material and structured to provide an opening on a top end of the sage candle system to allow igniting a top end of the longitudinal wick and wherein the external strapping material provides for structural support of the sage candle system during burning evolutions such that a functional integrity of the sage candle system is maintained during the burning evolutions and wherein the external strapping material provides for cinching a bottom end of the sage candle.

### RELATED APPLICATIONS

This application claims priority to U.S. Provisional Application No. 63/169,712 filed Apr. 1, 2021. The entire contents of the above application are hereby incorporated by reference as though fully set forth herein.

### FIELD OF THE INVENTION

The present invention relates generally to candles, and more particularly, to sage candle systems which provide centuries old spiritual and healing aromas.

### BACKGROUND OF THE INVENTION

Many methods and systems have been used in unsuccessful attempts to provide sage candles efficiently and effectively.

Additionally, past attempts have failed to provide a singular device for a person or a group of people to use in any environment to create sage candles with new and improved materials and methods to extend the life of the sage candles. Many of these unsuccessful attempts were costly and cumbersome for many people to adapt to.

Accordingly, there is an established need for a sage candle system. Further, there is an established need for sage candle systems which can provide a wide array of sage candle manufacturing methods to create new and improved sage candles in a cost-effective way using a plurality of materials that increase sage candle performance.

### SUMMARY OF THE INVENTION

According to an aspect of the present invention, sage candle construction methods which are able to incorporate new materials are provided. These innovations include new, useful, and non-obvious sage candle construction and methods.

In an aspect, a sage candle system suitable for use as a sage candle is provided. The system includes a longitudinal wick. The system also includes aggregate material configured for use as a candle arranged in a cylindrical fashion around the longitudinal wick. The system additionally includes an external covering material designed to cover an exterior surface of the aggregate material. Further still, the system includes external strapping material positionable on an exterior surface of the covering material and structured to provide an opening on a top end of the sage candle system to allow igniting a top end of the longitudinal wick and wherein the external strapping material provides for structural support of the sage candle system during burning evolutions such that a functional integrity of the sage candle system is maintained during the burning evolutions and wherein the external strapping material provides for cinching a bottom end of the sage candle system enabling the sage candle system to function as a sage candle effectively through consumption of the sage candle system throughout an effective life of the sage candle system.

In another aspect, a sage candle system suitable for use as a sage candle is provided. The system includes a longitudinal wick. The system also includes aggregate material configured for use as a candle arranged in a cylindrical fashion around the longitudinal wick. Additionally, the system includes an external covering material designed to cover an exterior surface of the aggregate material; and external strapping material positionable on an exterior surface of the covering material and structured to provide an opening on a top end of the sage candle system to allow igniting a top end of the longitudinal wick and wherein the external strapping material provides for structural support of the sage candle system during burning evolutions such that a functional integrity of the sage candle system is maintained during the burning evolutions and wherein the external strapping material provides for cinching a bottom end of the sage candle system enabling the sage candle system to function as a sage candle effectively through consumption of the sage candle system throughout an effective life of the sage candle system.

In embodiments, the sage candle system can include lavender essential oils, sage essential oils, and/or a plurality of essential oils infused within the system to allow controlled release of the aromatics and essences during burning of the candle system.

In embodiments, the sage candle system can include a singular unitary system manufactured to include all the benefits of a composite system.

In embodiments, the sage candle system can include paraffins, gels, soy, and/or beeswax.

In embodiments, the sage candle system can include pillar candles.

In embodiments, the sage candle system can include essences such as but not limited to vanilla, lavender, musk, and/or cedarwood.

In embodiments, the sage candle system can include candles with overall lengths of 5, 6, 7, 8, 9, 10, 11, and/or 12 inches or any dimension in between.

According to another aspect of the present invention, the sage candle can use rope, metal, plastics and other aromas to enhance the performance of the sage candle.

According to another aspect, the sage candle systems can incorporate organic and synthetic casings, wraps, center sections, burning holders, and other support material to contribute to candle performance.

According to yet another aspect, the sage candles can be constructed and combined with unique burning surfaces to increase performance.

According to another aspect, the packing of the sage candle can be modified to control the burn rate and change the number of aromas and oils that are being released over time.

In embodiments, a candle can be created in a metal and/or a silicone mold.

In embodiments, a wax rope, organic material, inorganic, composite, and/or a metallic based material can be applied onto an exterior of a main candle.

In embodiments, straps of material including wax and/or rope, can be wrapped around a main candle providing for support and structured to amplify additional aromatics when the candle is burned.

In embodiments, a wick or wax cord can be a colored wax wrapped around and melted to the main candle.

In embodiments, an exterior wrapping can be included to provide sufficient support to a candle to allow the candle to be inserted into a vertical candle holder and to be burned in place.

In embodiments, the system can include a plurality of sage components including leaves, essence oils, plant components, and other organic material infused with sage so as to allow aromatic release of sage while the candle is burning.

In embodiments, the system can include a candle designed to be placed horizontally in a shell type container while the candle is burned.

In embodiments, the system can include horizontally placed candles with a plurality of wicks coming out of the candle in order to produce an even burn of the candle and produce a homogeneous release of sage and/or other aromatics from the candle.

In embodiments, the system can include a candle holder similar to an incense holder which allows the candle to be burned and held in place by the incense holder like device.

In embodiments, an exterior of the candle can include silk screened images infused with aromatics, and other material which amplify the essences being emitted and the rate in which the aromatics are being released.

In embodiments, the exterior of the candle can include paints, ropes, strings, waxes, and/or metallic materials designed to control the burn rate of the candle and to have infused materials that will burn and give off their own aromatics and/or essences when the candle is burned at that location.

In embodiments, an internal of the candle system can include a plurality of smaller, thinner candle and/or sage branches, leaves, and/or other organic material rolled into cylindrically shaped items, and wherein the plurality of the smaller shaped items are held together by an external rope and/or strap like material designed to allow a controlled burn of the plurality of the smaller cylindrically shaped items together, as a unitary candle.

In embodiments, the exterior of the system can be irregular and configured to manually handle without depressing internal components.

In embodiments, the aggregate material can be homogeneous with respect to aromatics or aromatics and essences can be preferentially concentrated and structured to emit at a plurality of concentrations based on an axial position of where the candle system is being burned.

In embodiments, the smaller shaped items can be made from wax and/or organic material, handmade, production made, extruded, wicked and/or shaped manually to form a candle like system.

In embodiments, the system can include a singular wax type sage candle.

In embodiments, the system can include a plurality of thin wax type sage candles wrapped together to function as a unitary candle.

In embodiments, the system can include an internal wick.

In embodiments, the system can include an external wrap, the wrap can include a single or a plurality of leave type materials and/or coverings made of sage and/or other organic materials and/or aromatic materials configured to tightly contain the internal components of the system and to provide structural integrity during candle burning operations.

In embodiments, the system can include external crisscrossed straps to maintain structural integrity of the system.

In embodiments, the system can include a plurality of sage brush, sage leaves, and/or other organic leaves wrapped in a cylindrical shape and held together with external wrap straps.

In embodiments, the system can be configured to burn in a vertical position utilizing a vertical candle stand with a centralized spike to maintain the system in a vertical position during burning operations.

These and other objects, features, and advantages of the present invention will become more readily apparent from the attached drawings and the detailed description of the preferred embodiments, which are included in the attached appendices.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 illustrates a top perspective view of an embodiment of a sage candle system oriented in a vertical position;

FIG. 2 displays a horizontal front perspective view of an embodiment of the present invention utilizing a plurality of leaves wrapped in a cylindrical fashion;

FIG. 3A is a top view of a sage candle system stand configured to position the system in a vertical position for burning operations;

FIG. 3B is a side view of a sage candle stand configured for vertical operation;

FIG. 4 is a side perspective view of an embodiment of the present invention showing the system sustained in place with an incense style holder;

FIG. 5 is a top perspective view of an embodiment of the present invention showing a sage candle system resting upon a horizontal holding tray to support horizontal candle burning operations; and

FIG. 6 is a top perspective view of an embodiment of the present invention showing a horizontal burning position of a sage candle system utilizing a plurality of wicks to effect burning of the sage candle system.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

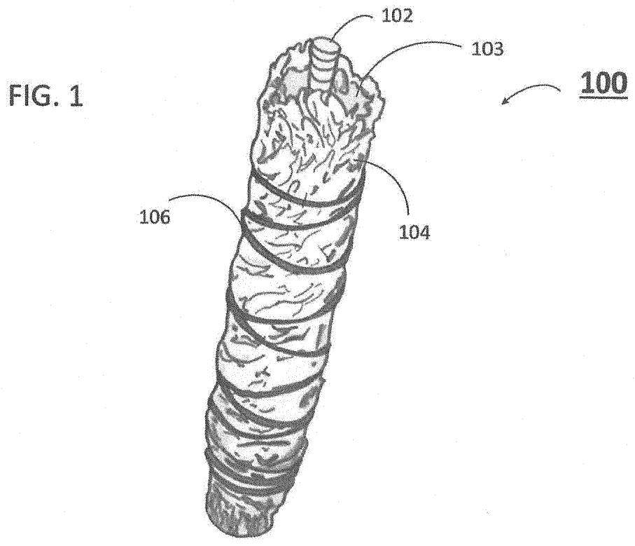

The following detailed description is exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to the FIG. 1, a vertically oriented sage candle system 100 is presented. The system 100 can include a centralized internal wick 102. The wick 102 configured to be placed within a center of the sage candle system 100, whether the system 100 consists of one or a plurality of thinner candle assemblies (not shown). The system 100 can also include an external covering 104. The system can include an aggregate material 103 configured for use as a candle arranged in a cylindrical fashion around the longitudinal wick 102. The external covering 104 can include sage leaves, organic leaves, aromatic leaves, synthetic wrapping material, wax sheets, and/or burn resistant material designed to allow internal components of the sage candle system 100, including the aggregate material 103 configured for use as a candle arranged in a cylindrical fashion around the longitudinal wick to burn and be consumed while the external covering 104 maintains structural integrity of the sage candle system 100.

Further still, the system 100 can include external straps, wrap ties, ribbons, and/or strips of material 106 designed to maintain the internal components of the sage candle system compact, tight, and configured to affect a sustainable operational burn of the system 100 while the consumable portions of the system 100 are utilized. The external tie straps 106 can be arranged in a plurality of fashions and may be arranged in a crisscrossed pattern to maintain the system 100 components in a tightly held manner.

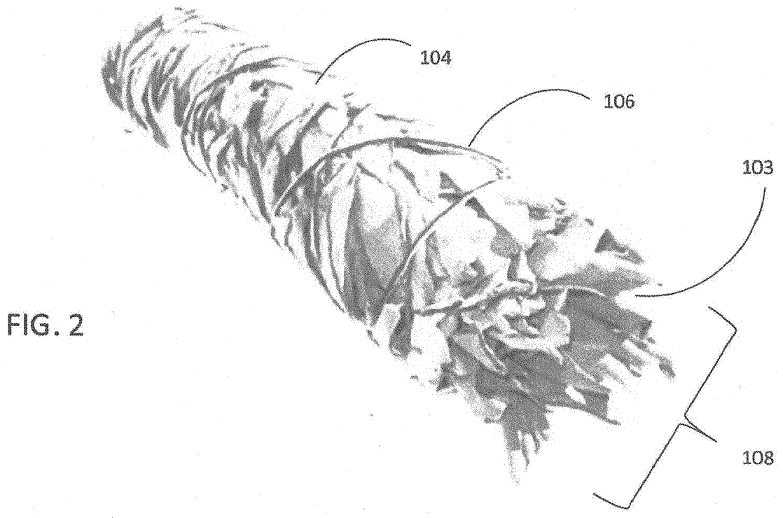

FIG. 2 depicts an embodiment of the system 100 wherein a plurality of leave like materials 108, such as found in cigar making evolutions, are wrapped tightly together to form a sage candle system 100. Such systems 100 may include a centralized wick and/or a plurality of internal wicks, each wick associated with an internally wrapped system. In embodiments as shown, the system 100 can function in a plurality of manners with the concept being that the sage candle system 100 will burn preferentially from one end to another. In embodiments as shown, the system 100 can include an external wrap 104 and external straps 106 structured to keep the internal components of the sage candle system 100, including the aggregate material 103 configured for use as a candle arranged in a cylindrical fashion around the longitudinal wick 102 tightly bound.

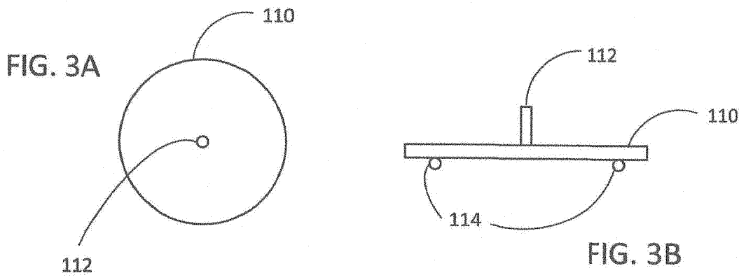

FIGS. 3A and 3B display top and side views of an embodiment of a vertical stand 110 for burning a sage candle system 100 in a vertical position. The vertical stand 110 can include a centralized top post 112 which can be of varying heights depending on the composition of the sage candle system 100. The stand 110 can also include a plurality of pedestal posts 114 oriented on a bottom of the stand 110.

It will be appreciated by persons skilled in the art that the present disclosure is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the disclosure.

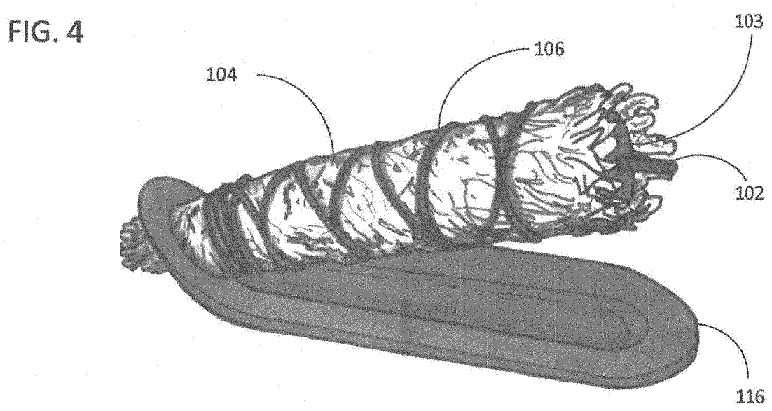

Turning to FIG. 4, an embodiment of the system 100 is shown deployed in a version similar to how an incense holder 116 would hold an incense rod. The composition of the system 100 can include variations with respect to external wrappings 104, and in embodiments may require reinforced crisscrossed straps 106 potentially positioned closer to one another and possibly wider in order to maintain structural integrity of the candle system 100 during burning operations and while suspended on an end in the incense holder 116. The system 100 can include an internal wick 102 and can also include a plurality of sage and/or organic leaves wrapped in a cigar style cylindrically forming a sage candle system 100.

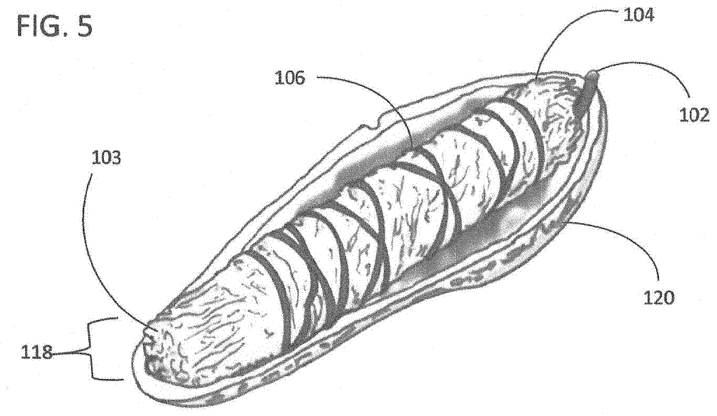

As best seen in FIG. 5, a sage candle system 100 can also be deployed in a horizontal dish 120 or horizontal holder 120 with the sage candle system 100 resting horizontally within the holder 120. In embodiments, the composition, including external wrappings 104 and the external bindings 106 can be of a modified nature due to the fact that the structural necessity of maintain the system 100 tightly bound is not required when the sage candle system 100 is resting on a holder 120. Therefore, the embodiments which can be utilized in horizontal applications can allow for looser wrappings, comingling of different waxes and organic materials as well as infusion of other aromatic materials which can be positioned throughout the sage candle system to allow a more even release of aromatics and essences during system 100 burn. In embodiments, the system can include a centralized wick 102.

Additionally, embodiments utilizing a horizontal deployment can include a grouping of smaller candle assemblies 118 and/or smaller sage and/or leave arrangements 118 bunched together to form a whole of a sage candle system 100.

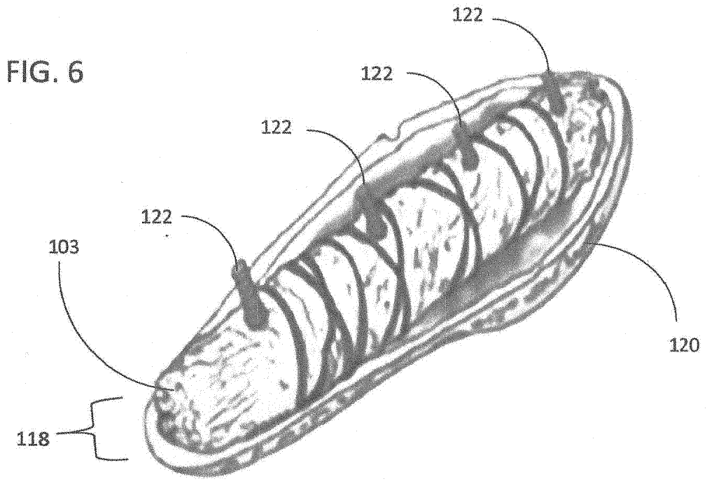

FIG. 6 displays an embodiment of the system 100 utilizing a plurality of wicks 122 positionable axially along a length of a sage candle system 100 configured to burn more evenly across the system 100 thereby allowing more control in aromatic and essence release from the system 100 during burning evolutions.

All references cited herein are expressly incorporated by reference in their entirety. In addition, unless mention was made above to the contrary, it should be noted that all of the accompanying drawings are not to scale. There are many different features to the present disclosure, and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

Insofar as the description above and the accompanying drawings disclose any additional subject matter that is not within the scope of the claims below, the inventions are not dedicated to the public and the right to file one or more applications to claim such additional inventions is reserved.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

The present invention has been described with reference to the preferred embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of implementation which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized the scope of this invention is much broader than presented by the claims. It is intended that broader claims will be submitted in an application that claims the benefit of priority from this application.

What is claimed:

1. A sage candle system suitable for use as a sage candle comprising:
a longitudinal wick;
aggregate material configured for use as a candle arranged in a cylindrical fashion around the longitudinal wick;
an external covering material designed to cover an exterior surface of the aggregate material; and
external strapping material positionable on an exterior surface of the covering material and structured to provide an opening on a top end of the sage candle system to allow igniting a top end of the longitudinal wick and wherein the external strapping material provides for structural support of the sage candle system during burning evolutions such that a functional integrity of the sage candle system is maintained during the burning evolutions and wherein the external strapping material provides for cinching a bottom end of the sage candle system enabling the sage candle system to function as a sage candle effectively through consumption of the sage candle system throughout an effective life of the sage candle system.

2. The system as recited in claim 1 wherein the longitudinal wick, the aggregate material, the external covering material, and the external strapping material are formed in a singular unitary piece.

3. The system as recited in claim 1 wherein the aggregate material includes wax and/or sage essential oil and/or lavender essential oil.

4. The system as recited in claim 1 wherein the wick includes organic and/or synthetic material configured for optimization of a life cycle for the sage candle system allowing for consumption of a majority of consumable sage candle system material during burning evolutions.

5. The system as recited in claim 1, wherein the external covering material includes sage leaves, other organic leaves, and/or synthetic material designed to emit aromatics and/or essences during burning evolutions of the sage candle system.

6. The system as recited in claim 1, wherein the aggregate material includes a plurality of sage and/or other leaves configured in a cylindrical fashion around the longitudinal wick rolled together as in a cigar rolled style.

7. The system as recited in claim 1, wherein the external strapping material includes widths of a plurality of dimensions and wherein the strapping material is positionable on the exterior of the external covering in a crisscrossed fashion.

8. The system as recited in claim 1, wherein the sage candle system includes concentrations of aromatics, essential oils, and other essences in a plurality of locations on the system and in varying concentrations designed to enhance and prolong emission of the aromatics, essential oils, and other essences during the life time of the sage candle system burning evolutions.
